(19) United States
(12) Patent Application Publication
(10) Pub. No.: US 2026/0131966 A1
(43) Pub. Date: May 14, 2026

(54) FALLEN LEAVES COLLECTION BAG AND METHOD FOR COLLECTING FALLEN LEAVES

(71) Applicant: Shenzhen AiChong Industrial Co., Ltd., Shenzhen (CN)

(72) Inventor: Aicheng Yin, Shenzhen (CN)

(21) Appl. No.: 19/404,337

(22) Filed: Dec. 1, 2025

Related U.S. Application Data
(63) Continuation-in-part of application No. 18/961,984, filed on Nov. 27, 2024, now abandoned.

(30) Foreign Application Priority Data
Nov. 8, 2024 (CN) 202422719488.5

(51) Int. Cl. B65F 1/00; B65F 1/10; B65F 1/14

(52) U.S. Cl. CPC B65F 1/0006; B65F 1/10; B65F 1/1415; B65F 2240/138

(57) ABSTRACT

Provided is a fallen leaves collection bag, including a main body portion and an extension portion. The main body portion is a container provided with an opening, including a bottom wall and a side wall. The bottom wall is connected to the side wall to encircle accommodating space. The extension portion extends outwards along a direction of the opening from the side wall, and one side of the extension portion is connected to the side wall. According to the fallen leaves collection bag provided by the present disclosure, by arranging the extension portion, during sweeping, the extension portion can be used to fix the position of the fallen leaves collection bag to ensure that the position of the main body portion and the direction of the opening are unchanged, so that dried grass and fallen leaves are swept into the accommodating space in an aligned manner.

### CROSS-REFERENCE TO RELATED APPLICATIONS

This application is a continuation-in-part of U.S. Patent Application No. US18/961,984, filed on November 27, 2024, which claims priority to Chinese Patent Application No. 202422719488.5 filed on November 08, 2024. The afore-mentioned applications are hereby incorporated by reference in their entireties.

### TECHNICAL FIELD

The present disclosure relates to the technical field of collecting containers, particularly to a fallen leave connection bag and a method for collecting fallen leaves.

### BACKGROUND

Landscape e maintenance includes mowing, weed pulling, bush trimming and leave cleaning. Landscape maintenance work may be involved in sweeping in public places and cleaning of yards in families. However, because weeds and fallen leaves are large in size, it is often time-consuming and labor-wasting to sweep the weeds and fallen leaves. Usually, weeds and fallen leaves are swept in a pile and are moved to a collecting container with a handle, a rake, or a shovel. However, there are no fallen leaves collection bags specially designed in the collecting container in the prior art. The openings of common bags are fixed. It is hard to align the weeds and fallen leaves. The weeds and fallen leaves are easy to move and scatter when being transferred, so that it is quite inconvenient to use the fallen leaves collection bags.

### SUMMARY

An object of the present disclosure is to provide a fallen leaves collection bag, which solves the problems of inconvenient operation and low cleaning efficiency.

In order to achieve the above object, the present disclosure uses the following technical solution.

A fallen leaves collection bag, including a main body portion and an extension portion. The main body portion is a container provided with an opening, including a bottom wall and a side wall. The bottom wall is connected to the side wall to encircle accommodating space. The extension portion extends outwards along a direction of the opening from the side wall, and one side of the extension portion is connected to the side wall.

A method for collecting fallen, including the following steps:

(a) providing a ground;

(b) providing fallen leaves and weeds to be collected, the fallen leaves and weeds being arranged on the ground; and

(c) providing a fallen leaves collection bag for collecting the fallen leaves and weeds, the fallen leaves collection bag including: a main body portion, the main body portion being a container provided with an opening and comprising: a bottom wall; a side wall, the bottom wall being connected to the side wall to encircle accommodating space; an extension portion, the extension portion extending outwards along a direction of the opening from the side wall, and one side of the extension portion being connected to the side;

(d) placing the fallen leaves collection bag on the ground, wherein the extension portion fits the ground and the opening faces the fallen leaves and weeds;

(e) guiding the fallen leaves and weeds to the upper side of the extension portion; and

(f) introducing the fallen leaves and weeds to the accommodating space through the opening.

Compared with the prior art, by arranging the extension portion, the fallen leaves collection bag is placed on a grassland during sweeping. Parts of the extension portion and the side wall fit the grassland. The weeds and fallen leaves pass through the extension portion first and then enter the accommodating space through the opening. Because the extension portion can be used to fix the position of the fallen leaves collection bag to ensure that the position of the main body portion and the direction of the opening are unchanged, it is easier to sweep the dried grass and fallen leaves into the accommodating space in an aligned manner. Moreover, the extension portion can further be used to cover the opening. In the transfer process after sweeping, the dried grass and fallen leaves are prevented from being scattered, so that the fallen leaves collection bag is convenient to use and improves the cleaning efficiency.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without making creative efforts.

FIG. 1 is a schematic diagram of a three-dimensional structure of a first embodiment of the fallen leaves collection bag in the present disclosure.

FIG. 2 is a schematic diagram of a three-dimensional structure of a second embodiment of the fallen leaves collection bag in the present disclosure.

FIG. 3 is a schematic diagram of a three-dimensional structure of a third embodiment of the fallen leaves collection bag in the present disclosure.

FIG. 4 is a schematic diagram of a three-dimensional structure of a fourth embodiment of the fallen leaves collection bag in the present disclosure.

FIG. 5 is a section view of the fourth embodiment of the fallen leaves collection bag in the present disclosure.

FIG. 6 is a schematic diagram of a three-dimensional structure of a fifth embodiment of the fallen leaves collection bag in the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. On the basis of the embodiments in the present disclosure, all other embodiments acquired by those of ordinary skill in the art without making creative efforts fall within the scope of protection of the present disclosure.

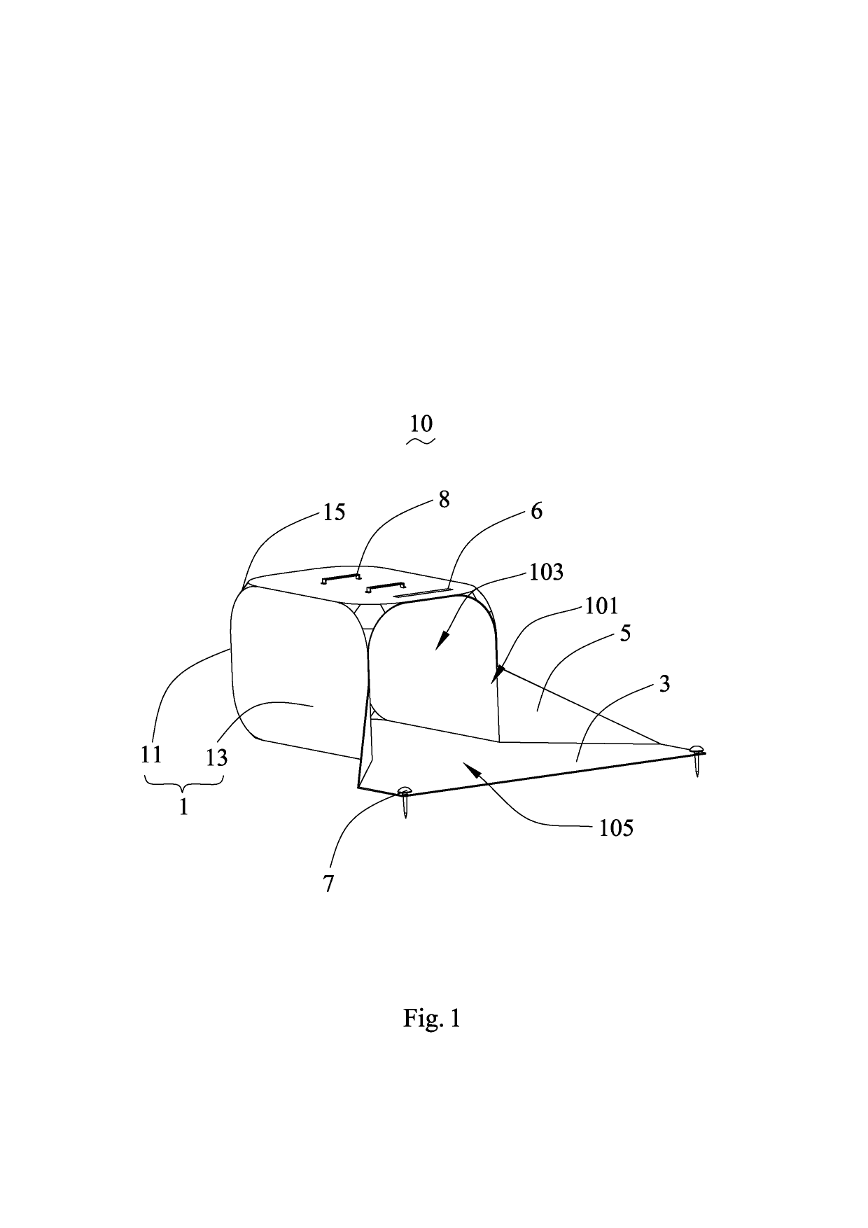

Referring to FIG. 1, FIG. 1 is a schematic diagram of a three-dimensional structure of a first embodiment of the fallen leaves collection bag 10 in the present disclosure. The fallen leaves collection bag 10 includes a main body portion 1, an extension portion 3 and connecting portions 5, where the main body portion 1 is a container provided with an opening 101 and the main body portion 1 includes a bottom wall 11 and a side wall 13, where the bottom wall 11 is connected to the side wall 13 to encircle accommodating space 103; and the extension portion 3 extends outwards along a direction of the opening 101 from the main body portion 1, and one side of the extension portion 3 is connected to the side wall 13 and/or the bottom wall 11. The extension portion 3 matches with the main body portion 1 to sweep dried grass and fallen leaves on the ground into the fallen leaves collection bag 10. Moreover, a user can apply a force to the extension portion 3 to control the direction of the opening 101 and the position of the fallen leaves collection bag 10 to prevent the fallen leaves collection bag from reciprocating in the sweeping process.

It shall be noted herein that the main body portion 1 can be of a cylindrical structure, a cuboid structure, or a polyhedral structure. The size of the corresponding opening 101 is consistent with the size of the bottom wall 11 or the size of the opening 101 is larger than the size of the bottom wall 11, which is not limited thereto. In the first embodiment, when the main body portion 1 is of the cuboid structure, the side wall 13 includes four planar structures, and the bottom wall 11 is of a square structure.

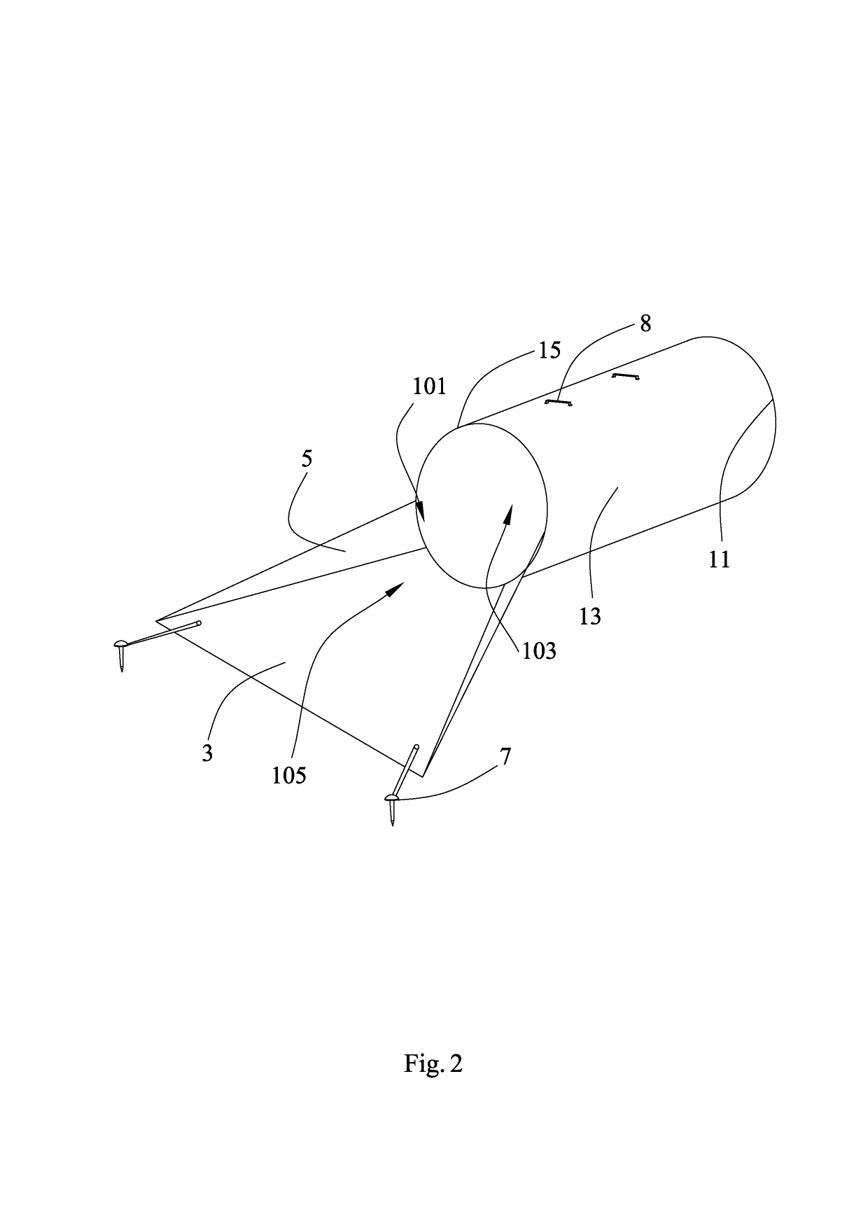

Referring to FIG. 2, FIG. 2 is a schematic diagram of a three-dimensional structure of a second embodiment of the fallen leaves collection bag 10 in the present disclosure. The main body portion 1 is of a barreled structure, the bottom wall 11 is of a cylindrical structure, and the side wall 13 is of a cambered structure. The fallen leaves collection bag 10 provided in the first embodiment and the second embodiment shows two structural configurations, and other configurations of the polyhedral structure are not described repeated herein.

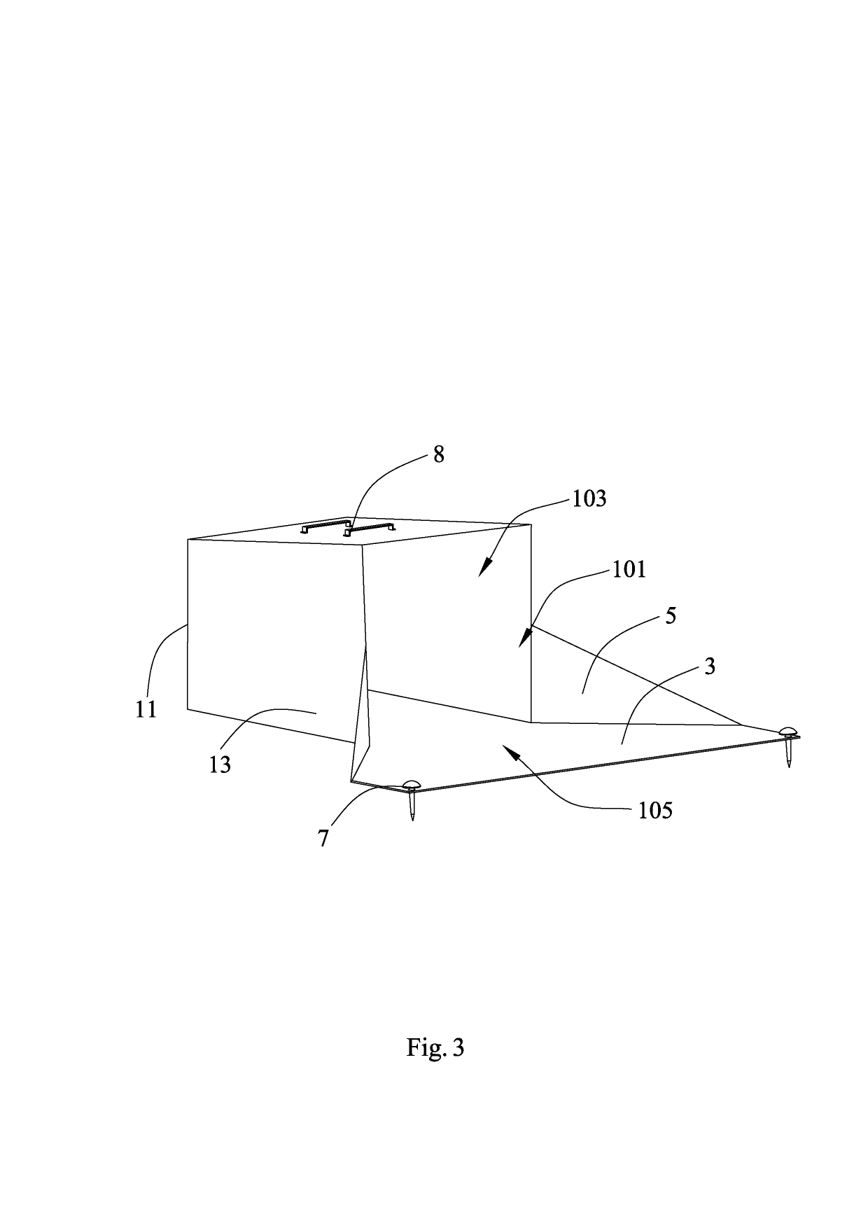

Referring to FIG. 3, FIG. 3 is a schematic diagram of a three-dimensional structure of a third embodiment of the fallen leaves collection bag 10 in the present disclosure. The size of the opening 101 is set greater than that of the bottom wall 11, the side wall 13 is of four trapezoidal structures, the connections to the bottom wall 11 are short edges of the trapezoidal structures, and the main body portion 1 integrally shrinks from the position of the opening 101 to the position of the bottom wall 11. This arrangement mode enlarges the size of the opening 101, facilitating the entering of the dried grass and fallen leaves.

Besides, the extension portion 3 and the main body portion 1 are arranged in an integrally formed manner or the extension portion 3 and the main body portion 1 are arranged in a separated manner. Taking the first embodiment as an example, the extension portion 3 and the side wall 13 are directly arranged in an integrated forming manner, so that it is convenient to process. Of course, the extension portion 3 and the side wall 13 can also be arranged as two separable structures separated by way of zippers, binding, suturing, or nailing, and are conveniently disassembled. The extension portion 3 can be cleaned and maintained independently or a new extension portion 3 can be used.

Furthermore, one side of the extension portion 3 is arranged in the accommodating space 103, on an outer peripheral side of the main body portion 1 or at an edge of the side wall 13 corresponding to the opening 101. In the first embodiment, the extension portion 3 extends outwards from the edge of the side wall 13 close to the opening 101, and one end of the extension portion 3 is connected to the side wall 13. This arrangement mode saves the material of the extension portion 3, so that the cost is relatively low.

Of course, in other embodiments, the extension portion 3 can further extend outwards along the direction of the opening 101 from the bottom wall 11, and the extension portion 3 is connected to the side wall 11. This arrangement can enhance the thickness of the side of the fallen leaves collection bag 10 close to the ground, the extension portion 3 and the side wall 13 are arranged in an overlapping manner, and when the extension portion 3 or the side wall 13 is worn, the dried grass, fallen leaves or fragments will not fall off. Besides, the extension portion 3 can further be connected to the side wall 13 as well to enhance the connecting strength between the extension portion 3 and the main body portion 1. The extension portion 3 and the side wall 13 fit more tightly to enhance the size of the accommodating space 103, so that more dried grass and fallen leaves can be stored.

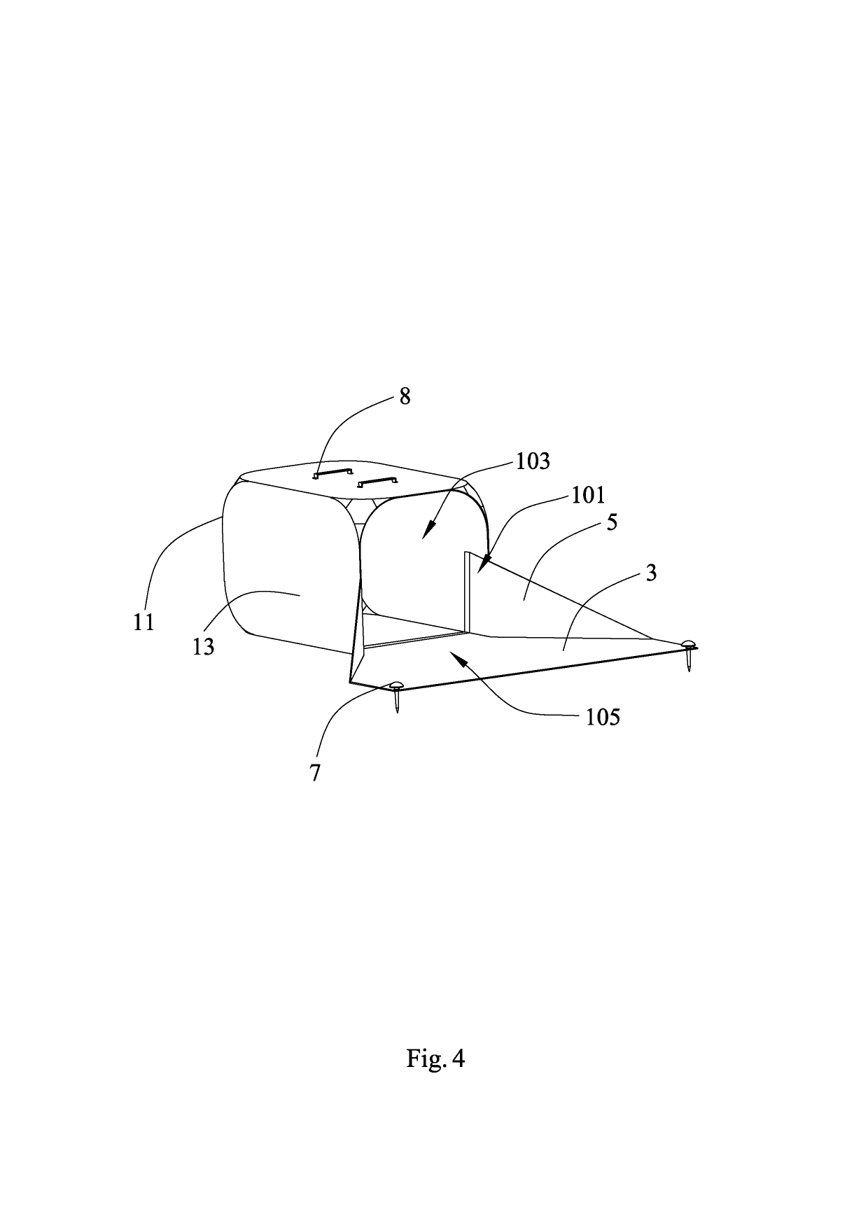

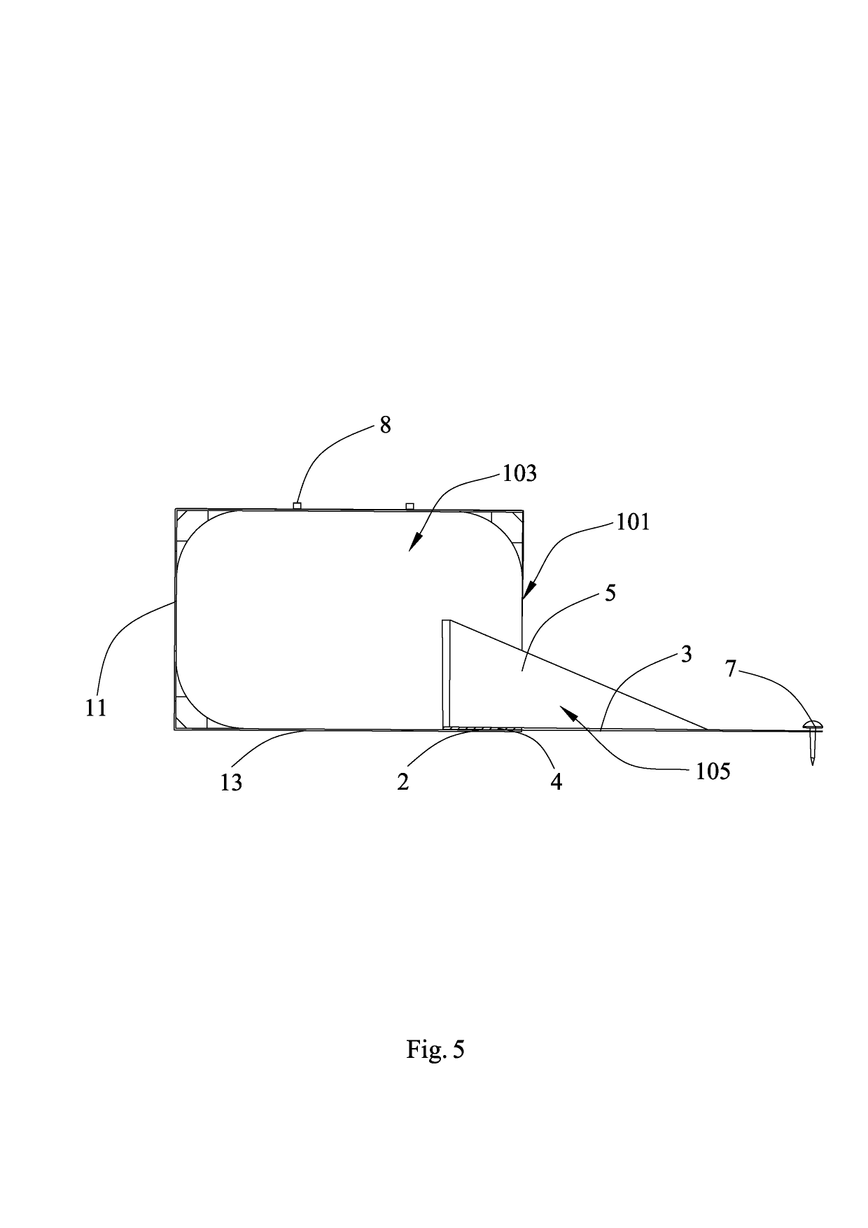

Referring to FIGS. 4 and 5, FIG. 4 is a schematic diagram of a three-dimensional structure of a fourth embodiment of the fallen leaves collection bag 10 in the present disclosure, and FIG. 5 is a section view of the fallen leaves collection bag 10 in the present disclosure. In the fourth embodiment, one side of the extension portion 3 is connected to an inner peripheral side of the side wall 13, a specific position of which is not defined. Of course, in other embodiments, one side of the extension portion 3 is connected to the outer peripheral side of the side wall 13. The thickness of the side wall 13 close to the position of the opening 101 is reinforced while the size of the extension portion 3 is reduced and the production cost is lowered.

In order to enhance the connecting strength and flexibility between the extension portion 3 and the side wall 13, the fallen leaves collection bag 10 further includes a first fitting piece 2 and a second fitting piece 4. The first fitting piece 2 is arranged on the inner wall of the side wall 13 and can also be arranged on the outer side. The second fitting piece 4 is arranged on the extension portion 3. The first fitting piece 2 and the second fitting piece 4 are opposite in position. The first fitting piece 2 and the second fitting piece 4 fit each other to connect the side wall 13 and the extension portion 3. This arrangement mode facilitates disassembly between the extension portion 3 and the side wall 13, enhancing the flexibility of the overall structure. After the extension portion 3 is detached, it can be placed in the accommodating space 103 to be stored, so that it is quite convenient. Moreover, when the extension portion 3 which is frequently used is damaged, the extension portion 3 can be replaced only, so that the maintenance cost is lowered.

The connecting portions 5 are arranged on both sides of the extension portion 3, and the connecting portions 5 are connected to the extension portion 3 and the main body portion 1. In the first embodiment, the connecting portions 5 are respectively connected to the edges of the extension portion 3 and the side wall 13 close to the opening 101, the connecting portions 5 and the extension portion 3 and the side wall 13 form a channel 105 relative to the opening 101. The dried grass and fallen leaves can approach the opening 101 through the channel 105 and enter the accommodating space 103 through the opening 101. Because the connecting portions 5 are connected to the extension portion 3 and the side wall 13, which is equivalent to fences arranged on both sides in front of the opening 101, when the dried grass and fallen leaves are swept, they arrive at the extension portion 3 first, the connecting portions 5 arranged on both sides ensure that the dried grass and fallen leaves are not scattered toward both sides and are aligned with the position of the opening 101, so that it is convenient for the dried grass and fallen leaves to enter. This arrangement mode reduces the size of the connecting portions 5 and lowers the production cost. Of course, in other embodiments, one side of each of the connecting portions 5 can be connected to the bottom wall 11. This arrangement can enhance the thickness of both sides of the fallen leaves collection bag 10, the connecting portions 5 and the side wall 13 are arranged in an overlapping manner, and when the extension portion 5 or the side wall 13 is worn, the dried grass, fallen leaves or fragments will not fall off. In the fourth embodiment, one side of each of the collecting portions 5 is connected to the inner peripheral side of the side wall 13, a specific position of which is not defined. Of course, in other embodiments, one side of each of the connecting portions 5 is connected to the outer peripheral side of the side wall 13. The thickness of the side wall 13 close to the position of the opening 101 is reinforced while the size of the connecting portions 5 is reduced and the production cost is lowered.

The width of the side of the extension portion 3 away from the main body portion 1 is greater than the width of the opening 101, and the extension portion 3 is connected to the side wall 13 in a folded manner and covers the opening 101 after being folded toward the main body portion 1. When the width of the side of the extension portion 3 away from the main body portion 1 is greater than the width of the opening 101, more dried grass and fallen leaves can enter the extension portion 3 in advance. Matched with the connecting portions 5, the efficiency that the dried grass and fallen leaves enter the accommodating space 103 can be improved. Because the connecting portions 5 are arranged on both sides of the extension portion 3, the connecting portions 5 are connected to both the extension portion 3 and the side wall 13, and the connecting portions 5 extend toward both outer sides from the opening 101 and are in a horn shape integrally, the dried grass and fallen leaves can be easier to be aligned with and close to the opening 101 along the channel 105. Besides, the extension portion 3 is connected to the side wall 13 or the bottom wall 11 in a folded manner. When sweeping is completed or the dried grass and fallen leaves fill the accommodating space 103, the extension portion 3 can be folded toward the main body portion 1. Because the extension portion 3 can cover the opening 101, when the fallen leaves collection bag 10 is transferred, the dried grass and fallen leaves will not be scattered from the opening 101 and the fallen leaves collection bag is stored conveniently.

In the first embodiment to the third embodiment, each of the connecting portions 5 includes a first side edge (not shown in the figures) and a second side edge (not shown in the figures), the first side edge fits the side wall 13, and the second side edge fits the extension portion 3. The connecting portions 5 are in continuous and sufficient contact with the side wall 13 and the extension portion 3 through the first side edge and the second side edge, ensuring that the dried grass and fallen leaves pass in the channel 105 smoothly and will not fall off outwards. Of course, in another embodiment, the connecting portions 5 can also be connected to the side wall 13 and the extension portion 3 by way of multi-point connection, for example, snap fit, suturing, nailing, and the like. It shall be noted herein that the connecting relation between the connecting portions 5 and the side wall 13 and the extension portion 3 include not only an integrally formed manner, but also a separable structure, and they are connected by way of zippers, binding, suturing or nailing. The connecting portions 5 are connected to the side wall 13 and the extension portion 3. Compared with the connecting mode between the extension portion 3 and the side wall 13, as shown in the fourth embodiment, the connecting portions 5 and the side wall 13 are connected through the first fitting piece 2 and the second fitting piece 4, which is not described repeatedly herein.

In order to facilitate storage and placement, the extension portion 3 and/or the connecting portions 5 are made of a flexible material. When it is not used at ordinary time, preferably, the extension portion 3 and the connecting portions 5 both are made of the flexible material. The extension portion 3 and the connecting portions 5 can be folded and storage arbitrarily, so that the fallen leaves collection bag is quite convenient and occupies small space. When it is needed to sweep the dried grass and fallen leaves, the extension portion 3 can be unfolded and placed relative to the main body portion 1. Because it is made of the flexible material, it can be guaranteed that the extension portion 3 fits the ground as much as possible. During sweeping, the dried grass and fallen leaves will not enter the gap between the extension portion 3 and the ground. Therefore, this arrangement mode increases the usage scenarios of the fallen leaves collection bag 10, and the fallen leaves collection bag will not be interfered by the terrain environment.

It shall be noted herein that the flexible material is different from hard materials such as metals, wood, and hard plastics and can be a flexible material of polyester fabric, oxford cloth and canvas. The fallen leaves collection bag can change the shape arbitrarily to fit more collecting scenes, and is also quite wear-resistant. The service life of the fallen leaves collection bag 10 can be prolonged.

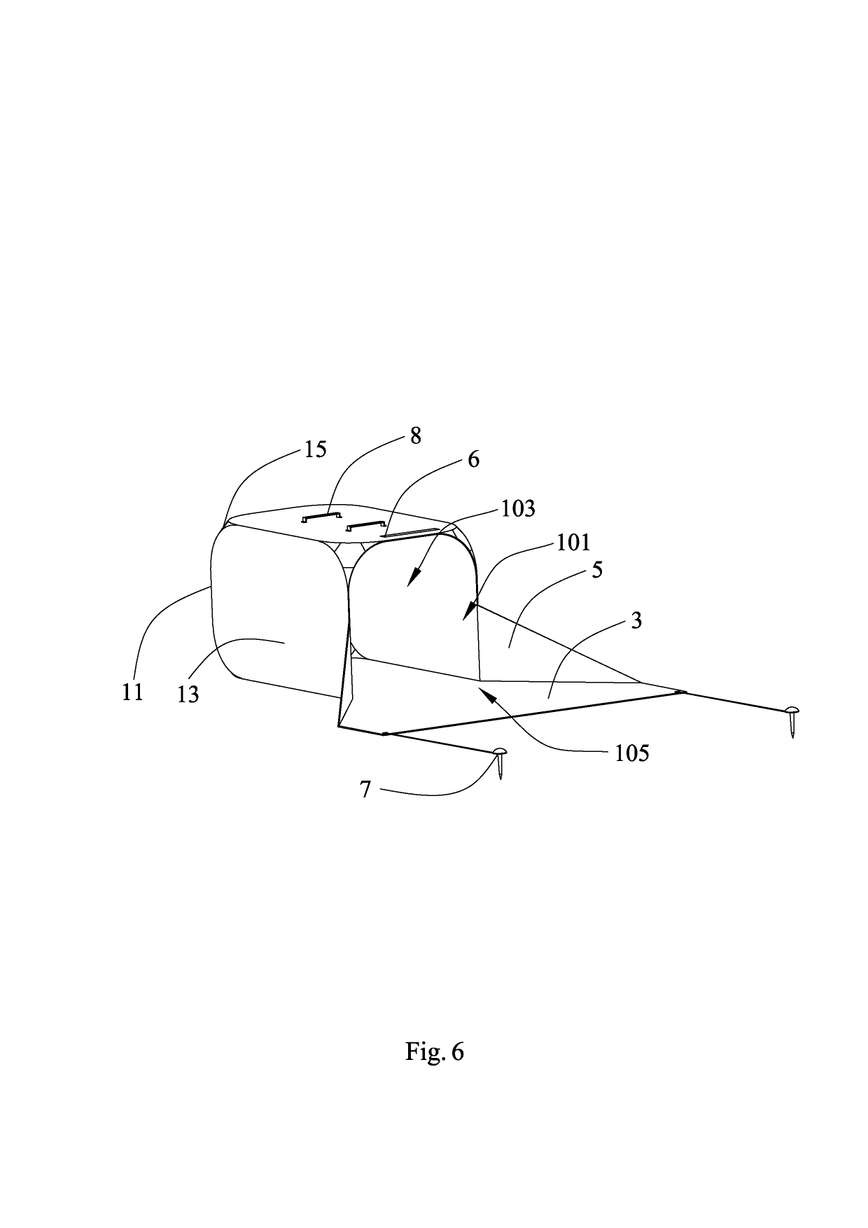

Referring to FIG. 1 and FIG. 6, FIG. 6 is a schematic diagram of a three-dimensional structure of a fifth embodiment of the fallen leaves collection bag 10 in the present disclosure. In order to ensure that the position of the fallen leaves collection bag 10 is more stable, the fallen leaves collection bag 10 further includes a fixing piece 7, and the fixing piece 7 is arranged on the extension portion 3 or is connected to the extension portion 3. When the fixing piece 7 is arranged on the extension portion 3, the fallen leaves collection bag can be directly mounted and fixed, so that the extension portion 3 fits the ground; of course, the fixing piece 7 can also be arranged separately and is connected to the extension portion 3 through structures such as a rope and a metal to fix the extension portion 3 as well.

The fixing piece 7 can be a grounding nail, the grounding nail being arranged at a corner of the extension portion 3 away from the opening 101 or connected to the corner of the extension portion 3 away from the opening 101. The grounding nail is simple in structure and convenient to mount, and the extension portion 3 can fit the ground more sufficiently due to the arrangement position of the grounding nail.

To further facilitate storage, the main body portion 1 and the extension portion 3 are provided with tapes 6 relatively. After sweeping is completed or the dried grass and fallen leaves fill the accommodating space 103, a user can fold the extension portion 3 toward the main body portion 1 and adhere the same through the tapes 6, so that the extension portion 3 covering the opening 101 is not easily separated, and it is convenient to fit and open the extension portion. Besides, the main body portion 1 is further provided with a handle 8, and the handle 8 is arranged on the outer peripheral side of the side wall 13, facilitating the user to transfer the fallen leaves collection bag 10 manually.

A supporting frame 15 is arranged at peripheral sides of the bottom wall 11 and the side wall 13 to fix the position of the opening 101 and the size of the accommodating space 103, so as to define the shape of the accommodating space 103. The supporting frame 15 can support the bottom wall 11 and the side wall 13 made of the flexible material, and the main body portion 1 can define the accommodating space 103 only depending on the supporting frame 15 without using a lot of hard materials. This arrangement mode can ensure that the main body portion 1, the extension portion 3 and the connecting portions 5 are made of the same flexible material, facilitating processing and production.

The working principle of the fallen leaves collection bag 10 is summarized as follows:

the fallen leaves collection bag 10 is placed on the ground, and the position of the main body portion 1 relative to the ground is adjusted, i.e., the side wall 13 close to one side of the extension portion 3 fits the ground;

the position of the extension portion 3 is adjusted, the extension portion 3 is paved to fit the ground, and because the extension portion 3 is made of the flexible material, it can fit the ground sufficiently;

the fixing piece 7 is mounted, and the fixing piece 7 penetrates into the ground to fix the position of the extension portion 3, ensuring that the extension portion 3 does not move easily;

the dried grass, fallen leaves and garbage fragments are gathered toward the extension portion 3, the connecting portions 5 match with the extension portion 3 to encircle the first channel 105, and the dried grass, fallen leaves and garbage fragments enter the accommodating space 103 via the first channel 105 and the opening 101 in sequence;

the fixing piece 7 is taken out, and the extension portion 3 folded toward the main body portion 1 covers the opening 101 and is connected and fixed through the tapes 6.

Compared with the prior art, by arranging the extension portion, 3 the fallen leaves collection bag 10 is placed on a grassland during sweeping. The extension portion 3 and the side wall 13 fit the grassland. The weeds and fallen leaves pass through the extension portion 3 first and then enter the accommodating space 103 through the opening 101. Because the extension portion 3 can be used to fix the position of the fallen leaves collection bag 10 to ensure that the position of the main body portion 1 and the direction of the opening 101 are unchanged, it is easier to sweep the dried grass and fallen leaves into the accommodating space 103 in an aligned manner. Moreover, the extension portion 3 can further be used to cover the opening 101. In the transfer process after sweeping, the dried grass and fallen leaves are prevented from being scattered, so that the fallen leaves collection bag is convenient to use and improves the cleaning efficiency.

Besides, the extension portion 3 matches with the connecting portions 5 to encircle the first channel 105, and the dried grass, fallen leaves and garbage fragments enter the accommodating space 103 via the first channel 105 and the opening 101 in sequence, so that the dried grass, fallen leaves and garbage fragments are prevented from being scattered from both sides of the main body portion 1 when passing through the opening 101, and the collecting efficiency is improved. Moreover, the extension portion 3 and the connecting portions 5 both are made of the flexible material, it can be guaranteed that the extension portion 3 fits the ground as much as possible. During sweeping, the dried grass and fallen leaves will not enter the gap between the extension portion 3 and the ground, so that the usage scenarios of the fallen leaves collection bag 10 are increased, and the fallen leaves collection bag will not be interfered by the terrain environment.

The above is merely exemplary implementation of the present disclosure. It shall be noted that those of ordinary skill in the art may make improvements without departing from the concept of the present disclosure and the improvements shall fall within the protection scope of the present disclosure.

What is claimed is:

1. A fallen leaves collection bag for collecting fallen leaves, weeds and other fragments, comprising:
a main body portion, the main body portion being a container provided with an opening and comprising:
a bottom wall;
a side wall, the bottom wall being connected to the side wall to encircle accommodating space; and
an extension portion, the extension portion extending outwards along a direction of the opening from the main body portion, and one side of the extension portion being connected to the side wall.

2. The fallen leaves collection bag according to claim 1, wherein the extension portion and the main body portion are arranged in an integrally formed manner or the extension portion and the main body portion are arranged in a separated manner; and
one side of the extension portion is arranged in the accommodating space, on an outer peripheral side or at an edge of the side wall corresponding to the opening.

3. The fallen leaves collection bag according to claim 1, further comprising:
a first fitting piece, the first fitting piece being arranged on the side wall and/or the bottom wall; and
a second fitting piece, the second fitting piece being arranged on the extension portion;
wherein the first fitting piece and the second fitting piece are opposite in position, and the first fitting piece fits the second fitting piece to connect the main body portion and the extension portion.

4. The fallen leaves collection bag according to claim 1, wherein the width of a side of the extension portion away from the main body portion is greater than the width of the opening, and the extension portion is connected to the side wall or the bottom wall in a folded manner and covers the opening after being folded toward the main body portion.

5. The fallen leaves collection bag according to claim 1, further comprising connecting portions, the connecting portions being arranged on both sides of the extension portion and connected to the main body portion.

6. The fallen leaves collection bag according to claim 5, wherein each of the connecting portion comprises:
a first side edge, the first side edge fitting the side wall and/or the bottom wall; and
a second side edge, the second side edge fitting the extension portion.

7. The fallen leaves collection bag according to claim 5, wherein the extension portion and/or the connecting portions both are made of a flexible material.

8. The fallen leaves collection bag according to claim 1, further comprising a fixing piece, the fixing piece being arranged on the extension portion and connected to the extension portion.

9. The fallen leaves collection bag according to claim 8, wherein the fixing piece is a grounding nail, the grounding nail being arranged at a corner of the extension portion away from the opening or connected to the corner of the extension portion away from the opening.

10. The fallen leaves collection bag according to claim 1, wherein a supporting frame is arranged at peripheral sides of the bottom wall and the side wall to define the shape of the accommodating space.

11. The fallen leaves collection bag according to claim 1, wherein the main body portion is of a cylindrical structure, a cuboid structure or a polyhedral structure.

12. The fallen leaves collection bag according to claim 1, wherein the main body portion integrally shrinks from the position of the opening to the position of the bottom wall.

13. The fallen leaves collection bag according to claim 5, wherein connections among the extension portion, the connecting portions and the main body portion are one of or a combination of snap fit, suturing, binding, nailing or zipper connections.

14. The fallen leaves collection bag according to claim 7, wherein the flexible material is one of or a combination of a polyester fabric, oxford cloth or canvas.

15. The fallen leaves collection bag according to claim 1, wherein the main body portion and the extension portion are provided with tapes relatively.

16. The fallen leaves collection bag according to claim 1, wherein the main body portion is further provided with a handle, the handle being arranged at the outer peripheral side of the side wall.

17. A method for collecting fallen leaves, comprising the following steps:
(a) providing a ground;
(b) providing fallen leaves and weeds to be collected, the fallen leaves and weeds being arranged on the ground;
(c) providing a fallen leaves collection bag for collecting the fallen leaves and weeds, the fallen leaves collection bag comprising:
a main body portion, the main body portion being a container provided with an opening and comprising:
a bottom wall;
a side wall, the bottom wall being connected to the side wall to encircle accommodating space; and
an extension portion, the extension portion extending outwards along a direction of the opening from the main body portion, and one side of the extension portion being connected to the side;
(d) placing the fallen leaves collection bag on the ground, wherein the extension portion fits the ground and the opening faces the fallen leaves and weeds;
(e) guiding the fallen leaves and weeds to the upper side of the extension portion; and
(f) introducing the fallen leaves and weeds to the accommodating space through the opening.

18. The method for collecting fallen leaves according to claim 17, further comprising the following step:
(g) folding the extension portion toward the main body portion to cover the opening.
